(19) United States
(12) Patent Application Publication
(10) Pub. No.: US 2022/0081002 A1
(43) Pub. Date: Mar. 17, 2022

(54) AUTONOMOUS DRIVING VEHICLE AND DYNAMIC PLANNING METHOD OF DRIVABLE AREA

(71) Applicant: SHENZHEN GUO DONG INTELLIGENT DRIVE TECHNOLOGIES CO., LTD, Shenzhen (CN)

(72) Inventor: JIANXIONG XIAO, Shenzhen (CN)

(21) Appl. No.: 17/343,701

(22) Filed: Jun. 9, 2021

(30) Foreign Application Priority Data
Sep. 16, 2020 (CN) 202010972378.3

(51) Int. Cl. B60W 60/00; G01C 21/34; G01C 21/00

(52) U.S. Cl. CPC B60W 60/0011; G01C 21/3415; B60W 2554/20; B60W 2552/00; G01C 21/3807

(57) ABSTRACT

The invention provides a dynamic planning method of drivable area. The dynamic planning method of drivable area includes steps of: the first step of obtaining the current; the location of the autonomous driving vehicle at any time; sensing the week of the autonomous driving vehicle. An environment data of surrounding environment is extracted from the environment data. According to the current time location of the autonomous driving vehicle. The second step of acquiring autonomous driving vehicle is to set up high-definition map and lane information. Extracting information about static objects from environmental data. To extract information about dynamic objects from environmental data. Dynamic information is configured to predict the motion of dynamic objects. According to the first drivable area, static information and moving track. The second drivable area is planned based on the track and lane information.

### CROSS REFERENCE TO RELATED APPLICATION

This non-provisional patent application claims priority under 35 U.S.C. § 119 from Chinese Patent Application No. 202010972378.3 filed on Sep. 16, 2020, the entire content of which is incorporated herein by reference.

### TECHNICAL FIELD

The disclosure relates to the technical field of autonomous driving, particularly relates to an autonomous driving vehicle and a dynamic planning method of drivable area.

### BACKGROUND

With the rapid development of autonomous driving vehicles, the autonomous driving technology is an inevitable trend of the vehicles. The autonomous driving technology adapts to a concept of friendliness and meets requirements of social development, such as high efficiency and low cost, and is more convenient for people's work and life. The autonomous driving technology includes four modules, of a position module, a perception module, a decision-making module, and a control module. The position module obtains the accurate a location of the vehicle in a specific map, the perception module dynamically collects and perceives information of the surrounding environment; the decision module processes the collected location and perception information and makes the drivable area, and the control module controls the vehicle to move horizontally or longitudinally according to the drivable area from the decision module.

Planning drivable area is a core technology in the field of autonomous technology. Planning drivable areas refers to planning a drivable area which does not collide with obstacles and meets kinematic constraints, environment constraints and time constraints of the vehicle when an initial state, a target state and an obstacle distribution in the environment of the vehicle are obtained. It is urgent to develop strategies to avoid obstacles, research suitable control methods, and plan different driving areas.

### SUMMARY

The disclosure provides a dynamic planning method of drivable area for an autonomous driving vehicle to solve above problems.

In a first aspect, a dynamic planning method of drivable area is provided. The dynamic planning method of drivable area comprises steps of: obtaining a location of the autonomous driving vehicle at a current time; perceiving environment data about environment around the autonomous driving vehicle; extracting lane information about lanes from the environment data, the lane information comprising locations of lane lines of the lanes; obtaining a first drivable area of the autonomous driving vehicle according to the location of the autonomous driving vehicle at the current time, a high-definition map, and the lane information, the first drivable area comprising lane areas locating between two edge lines of each lane, and a shoulder locating between each edge line of the lane and a curb respectively adjacent to each edge line of the lane; extracting static information about static objects from the environment data, the static information containing locations of the static objects and regions of the static objects; extracting dynamic information about dynamic objects from the environment data, and predicting trajectories of the dynamic objects according to the dynamic information; and planning a second drivable area according to the first drivable area, the static information, the trajectories of the dynamic objects, and the lane information.

In a second aspect, an autonomous driving vehicle is provided. The autonomous driving vehicle comprising: a memory configured to store program instructions; one or more processors configured to execute the program instructions to perform a dynamic planning method of drivable area, the dynamic planning method of drivable area for an autonomous driving vehicle comprising: obtaining a location of the autonomous driving vehicle at a current time; perceiving environment data about environment around the autonomous driving vehicle; extracting lane information about lanes from the environment data, the lane information comprising locations of lane lines of the lanes; obtaining a first drivable area of the autonomous driving vehicle according to the location of the autonomous driving vehicle at the current time, a high-definition map, and the lane information, the first drivable area comprising lane areas locating between two edge lines of each lane, and a shoulder locating between each edge line of the lane and a curb respectively adjacent to each edge line of the lane; extracting static information about static objects from the environment data, the static information containing locations of the static objects and regions of the static objects; extracting dynamic information about dynamic objects from the environment data, and predicting trajectories of the dynamic objects according to the dynamic information; planning a second drivable area according to the first drivable area, the static information, the trajectories of the dynamic objects, and the lane information.

In a third aspect, a medium is provided. The medium comprising a plurality of program instructions, the program instructions executed by one or more processors to perform a dynamic planning method of drivable area, the dynamic planning method of drivable area for an autonomous driving vehicle comprising: obtaining a location of the autonomous driving vehicle at a current time; perceiving environment data about environment around the autonomous driving vehicle; extracting lane information about lanes from the environment data, the lane information comprising locations of lane lines of the lanes; obtaining a first drivable area of the autonomous driving vehicle according to the location of the autonomous driving vehicle at the current time, a high-definition map, and the lane information, the first drivable area comprising lane areas locating between two edge lines of each lane, and a shoulder locating between each edge line of the lane and a curb respectively adjacent to each edge line of the lane; extracting static information about static objects from the environment data, the static information containing locations of the static objects and regions of the static objects; extracting dynamic information about dynamic objects from the environment data, and predicting trajectories of the dynamic objects according to the dynamic information; planning a second drivable area according to the first drivable area, the static information, the trajectories of the dynamic objects, and the lane information.

As described above, the dynamic planning method can plan the drivable area for the autonomous driving vehicle based on the environment around the autonomous driving vehicle at the current moment, analysis of the lane information, the static information, and the dynamic information in the surrounding environment, which may get a drivable area which is big enough for the autonomous driving vehicle drive continually when there are obstacles.

### BRIEF DESCRIPTION OF THE DRAWINGS

In order to illustrate the technical solution in the embodiments of the disclosure or the prior art more clearly, a brief description of drawings required in the embodiments or the prior art is given below. Obviously, the drawings described below are only some of the embodiments of the disclosure. For ordinary technicians in this field, other drawings can be obtained according to the structures shown in these drawings without any creative effort.

FIG. 1 is a flow chart of the dynamic planning method in accordance with an embodiment.

FIG. 2 is a schematic diagram of environment around the autonomous driving vehicle in accordance with an embodiment.

FIG. 3 is a schematic diagram of the environment around the autonomous driving vehicle in accordance with an embodiment.

FIG. 4 is a schematic diagram of the first drivable area in accordance with an embodiment.

FIG. 5 is a schematic diagram of the first drivable area in accordance with an embodiment.

FIG. 6 illustrates a block diagram of the system for recognizing traffic lights in accordance an embodiment.

FIG. 7 is a schematic diagram of the third drivable area in accordance with an embodiment.

FIG. 8 is a schematic diagram of the third drivable area in accordance with an embodiment.

FIG. 9 is a flow chart for extracting static information of an unrecognized object in accordance with an embodiment.

FIG. 10 is an enlarged view of a portion X of the environment around the autonomous driving vehicle shown in FIG. 2.

FIG. 11 is a flow chart for extracting static information of a movable object in a static state in accordance with an embodiment.

FIG. 12 is an enlarged view of a portion Y of the environment around the autonomous driving vehicle.

FIG. 13 is a schematic diagram of the moving track of a dynamic object in accordance with an embodiment.

FIG. 14 is a sub flow chart of the dynamic planning method in accordance with an embodiment.

FIG. 15 is a schematic diagram of the drivable route in accordance with an embodiment.

FIG. 16 is a schematic diagram of the internal structure of the dynamic planning system in accordance with an embodiment.

FIG. 17 is a schematic diagram of an autonomous driving vehicle in accordance with an embodiment.

FIG. 18 is a schematic diagram of the autonomous driving vehicle in accordance with an embodiment.

### DETAILED DESCRIPTION OF THE EMBODIMENTS

In order to make the purpose, technical solution and advantages of the disclosure more clearly, the disclosure is further described in detail in combination with the drawings and embodiments. It is understood that the specific embodiments described herein are used only to explain the disclosure and are not used to define it. On the basis of the embodiments in the disclosure, all other embodiments obtained by ordinary technicians in this field without any creative effort are covered by the protection of the disclosure.

The terms “first”, “second”, “third”, “fourth”, if any, in the specification, claims and drawings of this application are used to distinguish similar objects and need not be used to describe any particular order or sequence of priorities. It should be understood the data used here are interchangeable where appropriate, in other words, the embodiments described can be implemented in order other than what is illustrated or described here. In addition, the terms “include” and “have” and any variation of them, can encompass other things. For example, processes, methods, systems, products, or equipment that comprise a series of steps or units need not be limited to those clearly listed, but may include other steps or units that are not clearly listed or are inherent to these processes, methods, systems, products, or equipment.

It is to be noted that the references to “first”, “second”, etc. in the disclosure are for descriptive purpose only and neither be construed or implied the relative importance nor indicated as implying the number of technical features. Thus, feature defined as “first” or “second” can explicitly or implicitly include one or more such features. In addition, technical solutions between embodiments may be integrated, but only on the basis that they can be implemented by ordinary technicians in this field. When the combination of technical solutions is contradictory or impossible to be realized, such combination of technical solutions shall be deemed to be non-existent and not within the scope of protection required by the disclosure.

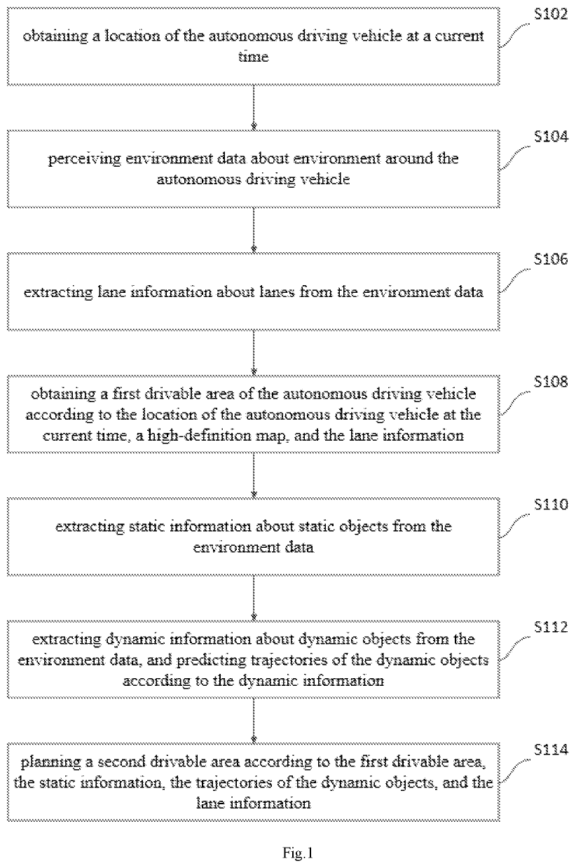

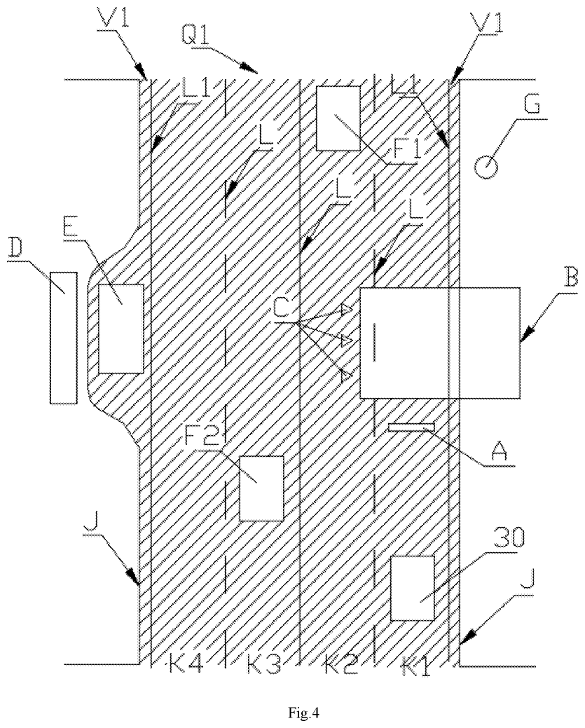

Referring to FIG. 1, and, FIG. 3 the autonomous driving vehicle 30 may be a motorcycle, a truck, a sports utility vehicle (SUV), a leisure vehicle, etc. Vehicles (RV), ships, aircrafts and any other transport equipment. In an exemplary embodiment, the autonomous driving vehicle 30 has all the required features So called four or five level automation system. Level-four automation system refers to “high automation”, with level-four automation system in principle, the human driver is no longer required to participate in the vehicle within autonomous driving vehicle's functional scope, even if the human driver has no response to the intervention request with appropriate response, the vehicle also have the ability to automatically reach the minimum risk state. Five level system refers to “full automation”, with Vehicles with five level automation system can realize autonomous driving in any legal and drivable road environment the driver only needs to set the destination and turn on the system, and the vehicle can drive to the designated place through the optimized route. since the dynamic planning method of moving vehicle trajectory includes following steps S102-S114.

In the step S102, the autonomous driving vehicle 30 obtains a location of the autonomous driving vehicle at a current time. In detail, the method obtains the current location of the autonomous driving vehicle 30 through the location module 31 set on the autonomous driving vehicle 30. Among them, location module 31 includes but is not limited to the global location system, the Beidou satellite navigation system, an inertial measurement unit, etc.

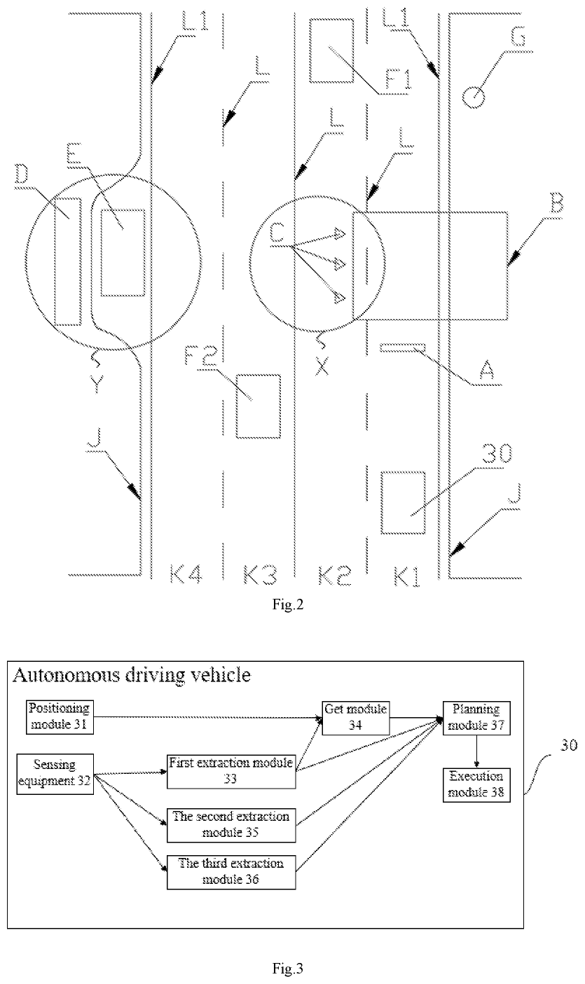

In the step S104, environment data about environment around the autonomous driving vehicle is perceived. In detail, in this embodiment, the step S104 is performed as: first, detecting the environment around the autonomous driving vehicle 30 through the sensing device 32 set in the autonomous driving vehicle 30 to obtain the sensing data; and then the sensing data is processed to generate the environment data according to a pre fusion prediction algorithm or a post fusion prediction algorithm. In this embodiment, the sensing device 32 is sensor device in an integrated flat shape, and the sensing device 32 is arranged in a middle of a top side of the autonomous driving vehicle 30. In some implement embodiments, the sensing device 32 may be but not limited to a convex sensor device or separated sensor devices. And the sensing device 32 may be installed in other position of the autonomous driving vehicle 30 rather than the middle of the top side of the autonomous driving vehicle 30. The sensing device 32 includes but is not limited to radars, lidars, thermal image sensors, image sensors, infrared instruments, ultrasonic sensors, and other sensors with sensing function. In this embodiment, the sensing device 32 obtains the sensing data around the autonomous driving vehicle 30 by various sensors. The sensing data includes but is not limited to radar detection data, lidar detection data, thermal imager detection data, image sensor detection data, infrared detector detection data, ultrasonic sensor detection data, etc. When the sensing data is processed by the pre fusion sensing algorithm, the sensing data detected by the various sensors will be synchronized, and the synchronized data is then perceived to generate the environmental data. When the sensing data is processed by the post fusion prediction algorithm, the sensing data detected by the various sensors will be perceived, to generate target data and the target data is then fused to generate the environmental data. In some implement embodiments, the sensing data can also be processed via a hybrid fusion sensing algorithm, or a combination of multiple fusion sensing algorithms. When the sensing data is processed by the hybrid fusion sensing algorithm, the sensing data processed by each of the pre fusion sensing algorithm and a part of the sensing data is processed by the post fusion prediction algorithm and the sensing data processed is then mixed to generate the environmental data. When the sensing data is processed by a combination of multiple fusion sensing algorithms, the sensing data is processed by via fusion sensing algorithms being performed in parallel to generate the environmental data, the fusion sensing algorithms include the post fusion prediction algorithm, the pre fusion sensing algorithm, the hybrid fusion sensing algorithm, or fusion sensing algorithms which are constructed by combined the post fusion prediction algorithm, the pre fusion sensing algorithm, the hybrid fusion sensing algorithm in a predetermined rule. How to generate the environmental data will be described combining the FIG. 2 in detail below.

In the step S106, lane information about lanes from the environment data is extracted. As shown in FIG. 3 the lane information is extracted from the environment data via the first extraction module 33 set on the autonomous driving vehicle 30. The lane information includes locations of lane lines L, the color of the lane lines L, semantic information of lane lines L, and a lane on which the autonomous driving vehicle 30 are driving on. For example, the surrounding environment includes four lanes K1, K2, K3, and K4, in other words, the four lanes K1, K2, K3, and K4 forms a two-way four lanes. The lane K1 and lane K2 are in the same direction, Lane K3 and lane K4 are in the same direction opposite to the lane K1 and lane K2. In this embodiment, the autonomous driving vehicle 30 is driving on the lane K1 which is a rightmost lane.

In the step S108, a first drivable area of the autonomous driving vehicle is obtained according to the location of the autonomous driving vehicle at the current time, a high-definition map, and the lane information. As shown in FIG. 3, the first drivable area Q1 is acquired through an acquisition module 34 set on the autonomous driving vehicle 30. The first drivable area includes lane areas locating between two edge lines of each lane, and a shoulder locating between each edge line of the lane, and a curb respectively adjacent to each edge line of the lane. For example, as shown in FIG. 4, the first drivable area Q1 includes lane areas between two lane edge lines L1 and a shoulder V1 between each edge lines of the lane L1 and adjacent curb J. In detail, the first drivable area Q1 includes four lanes K1, K2, K3, K4 and two shoulders V1 between two lane edge lines L1 and adjacent curb J. When a current lane on which the autonomous driving vehicle 30 is driving on exists obstacles which blocks the autonomous driving vehicle 30. The obstacles may be traffic cones, construction road signs, temporary construction protective walls, etc. The autonomous driving vehicle 30 need to enable a part of the autonomous driving vehicle 30 move out of the current land to make a detour to avoid the obstacles and drive continually. And it is necessary to enlarge the drivable area of the autonomous driving vehicle 30 by adding areas not including in any lands but near the edge of the current land that the autonomous driving vehicle 30 can enable a part of the autonomous driving vehicle 30 avoid the obstacles. For example, it can be understood that the shoulder V1 between the edge lines of the lane L1 and the adjacent curb J which is not included in the land area also can be determined as a part of the first drivable area. In detail, when the current lane is occupied by a other vehicles in the adjacent lane, or obstacles, the autonomous driving vehicle should drive on the shoulder for leaving away from the current, and the shoulder can determine as a part of the first drivable area for the autonomous driving vehicle 30.

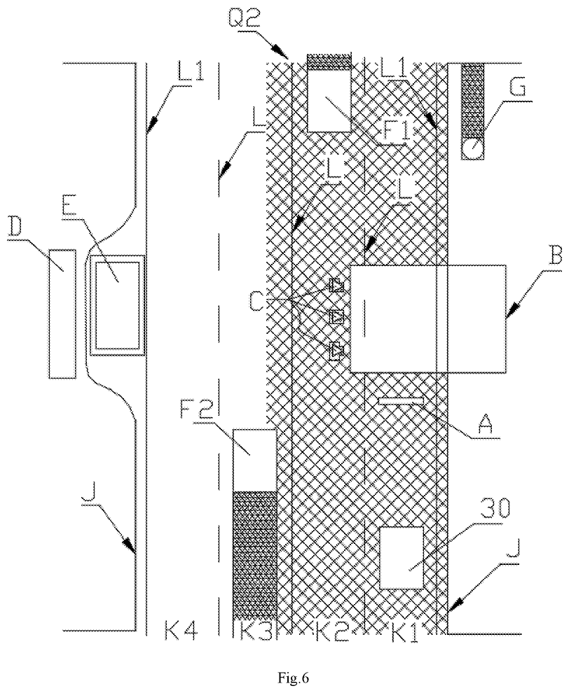

In the step S110, static information about static objects is extracted from the environment data. As shown in FIG. 3, the static information is extracted via a second extraction module 35 of the autonomous driving vehicle 30. The static information includes locations of the static objects and regions of the static objects. For example, the static objects include but are not limited to static pedestrians, static vehicles, traffic cones, construction road signs, temporary construction protective walls, etc. As shown in FIG. 6, for example, in the current surrounding environment, the static objects include a construction signboard A in front of the driving direction of the autonomous driving vehicle 30, a temporary construction protective wall B on a side of the construction signboard A away from the autonomous driving vehicle 30, the traffic cone C on a side of the temporary construction protective wall B away from the curb J, and a bus E on the leftmost lane stopping at the bus stop D. The area surrounded by the temporary construction protective wall B includes a right curb J, a part of the shoulder between the right edge lines of the lane L1 and the right curb J, a part of the current lane K1, and a part of the left lane K2 on the left side of the autonomous driving vehicle 30. How to extracting corresponding static information for different static objects will be described in detail below.

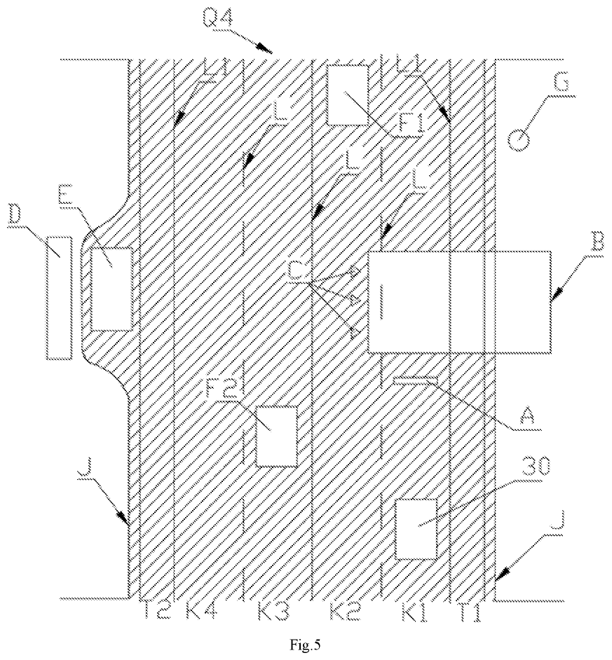

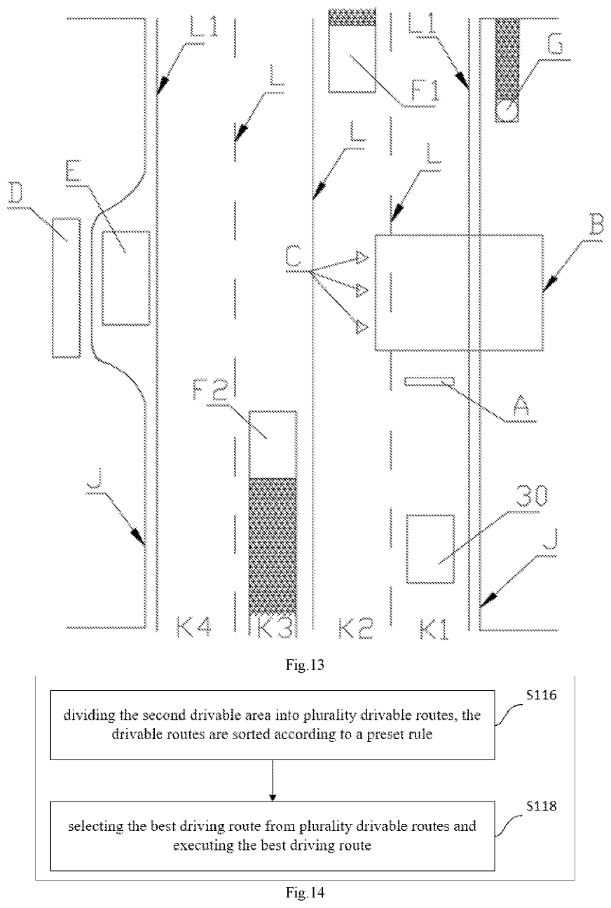

In the step S112, dynamic information about dynamic objects is extracted from the environment data, and predicting trajectories of the dynamic objects according to the dynamic information. As shown in FIG. 3, the dynamic information is extracted via a third extraction module 36 arranged on the autonomous driving vehicle 30. The dynamic objects include but are not limited to vehicles in the lane, pedestrians walking on the sidewalk, pedestrians crossing the road, etc. The dynamic information includes but are not limited to locations of the dynamic objects, movement directions of the dynamic objects, the speed of the dynamic objects, etc. As shown in FIG. 5, in the current surrounding environment, dynamic objects include pedestrian G walking on a right sidewalk, a vehicle F1 driving on a lane K2, and a vehicle F2 driving on a lane K3. The pedestrian G walks toward the autonomous driving vehicle 30, the vehicle F1 is to leave away from the current surrounding environment, and the vehicle F2 locates in front left of the autonomous driving vehicle 30 and has passed an area opposite to a temporary construction protective wall B. The third extraction module 36 expresses each of the dynamic objects by regular shapes, such as a cube, a cuboid, or other polyhedrons, and predicts the corresponding motion trajectories of the dynamic objects according to the dynamic information. As shown in FIG. 13, furthermore, in the current surrounding environment, the pedestrian G, the vehicle F1 and the vehicle F2 can be converted as cuboids. The motion trajectories of the pedestrian G, the vehicle F1, and the vehicle F2 are converted extendable cuboids extending infinitely along corresponding motion directions.

In the step S114, a second drivable area is planned according to the first drivable area, the static information, the trajectories of the dynamic objects, and the lane information. As shown in FIG. 3, the second drivable area Q2 is planned by the planning module 37 arranged on the autonomous driving vehicle 30, which will be described in detail below.

In this embodiment, the environment around the autonomous driving vehicle 30 at the current moment is sensed and the environment data is obtained, and the lane information. The lane information about lanes, the static information about static objects and the dynamic information about dynamic objects are extracted from environmental data synchronously or asynchronously. the first drivable area of the autonomous driving vehicle is obtained according to the current location of the autonomous driving vehicle, high-definition map and lane information. In addition to the drivable lane, the first drivable area also includes the shoulder, and the autonomous driving vehicle is capable of driving beyond the lane. The static information, the dynamic information, and the trajectory of the autonomous driving vehicle are then dynamically planned according to the first drivable area and the lane information.

Referring to FIG. 5, the difference between the first drivable area Q4 provided by the second embodiment and the first drivable area Q1 provided by the first embodiment is that the first drivable area Q4 provided by the second embodiment also includes a bicycle lane T1 on the right side of lane K1 and a bicycle lane T2 on the left side of lane K4. Other senses of the first drivable area Q4 provided by the second embodiment is approximately the same as that of the first drivable area Q1 provided by the first embodiment, and will not be described again. In some implement embodiments, the first drivable area Q1 also includes a roadside parking area for the autonomous driving vehicle 30 to drive.

In this embodiment, the first drivable area also includes the bicycle lanes on both sides of the lane, the roadside parking area and so on, and the drivable area for the autonomous driving vehicle is further to enlarge, and the area which can be used to dynamically planned the motion trajectories becomes lager.

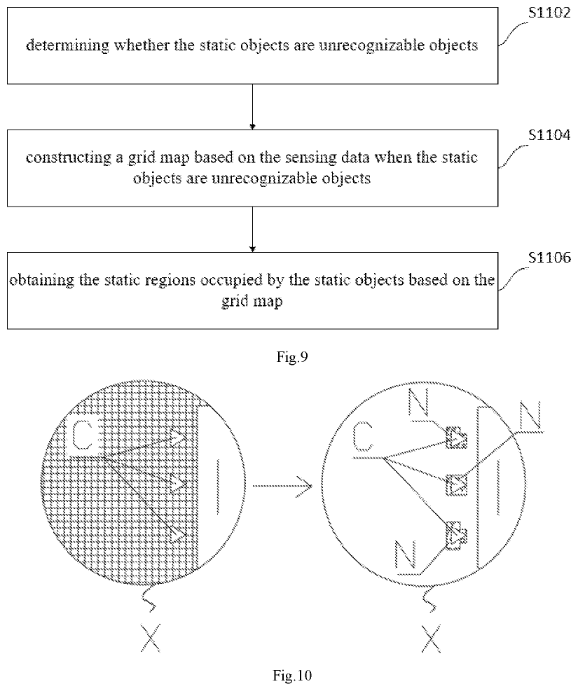

Referring to FIG. 9 and FIG. 10, illustrates a flowchart of the step S110. The step S110 of extracting the static information about the static object from the environment data includes the following steps.

In the step S1102, it is determined that whether the static objects are unrecognizable objects. In detail, the current surrounding environment of the autonomous driving vehicle 30 may include objects that cannot be recognized by the autonomous driving vehicle 30, so other methods need to be used for recognition.

In the step S1104, a grid map constructed based on the sensing data when the static objects are unrecognizable objects. In detail, the grid map is an occupancy grid map. The occupancy grid map is constructed based on the lidar detection data obtained by the lidars of the sensing device 32. In detail, the current surrounding environment is divided to form a grid map, and each grid of the grid map. has a state of a free state or an occupied state.

In the step S1106, the static regions occupied by the static objects are obtained based on the grid map. Furthermore, how to obtain the static regions is determined by the states of the grids of the grid map. When the state of the grid is occupied, an area according to the grid is occupied by the unrecognized objects. When the state of the grid is empty, an area according to the grid is not occupied by the unrecognized objects. For example, as shown in FIG. 10, when a traffic cone C existing in the current surrounding environment is a rare traffic cone, the autonomous driving vehicle 30 can't recognized. The autonomous driving vehicle 30 then constructs the gird map and obtains the grips of the occupied state as the girds occupied by the traffic cone C. Next, the occupied grids are spliced together to form the static regions N occupied by traffic cone C.

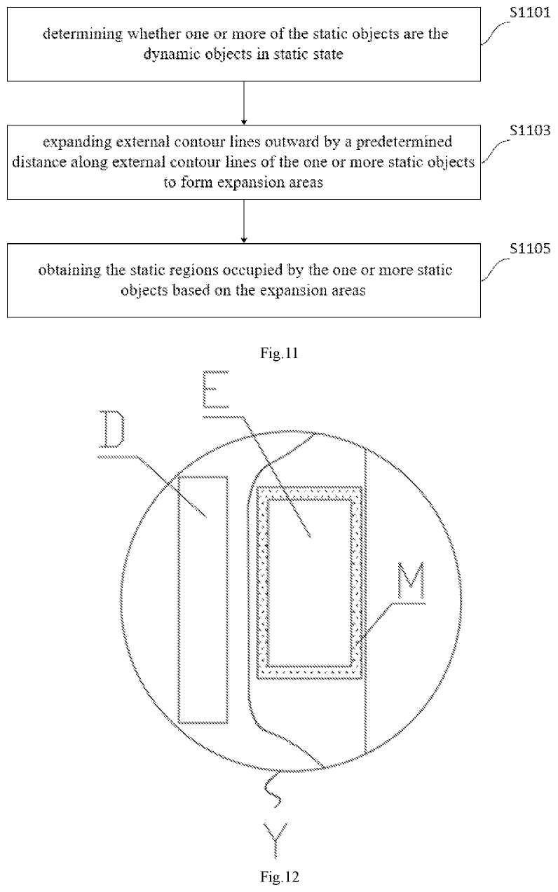

Referring to FIG. 11 and FIG. 12, The step S110 of extracting the static information about the static object from the environment data, includes the following steps S1101-S1105.

In the step S1101, it is determined that whether one or more of the static objects are dynamic objects in static state. In detail, one dynamic object in static state is an object which is in a static state at the current moment but turns to a dynamic state at the next moment. The dynamic objects in static state may be but not limited to still vehicles, still pedestrians, and still animals. For one example, one of the still pedestrians will extend his arms or legs at the next moment, or walk in a certain direction at the next moment. For other example, there will be other objects extending out of a still vehicle at the next moment. In detail, the sill vehicle may open the door at the next moment, or a wheelchair for the disabled may stretch out of a door of a bus stopping at a bus stop at the next moment, or goods may be moved out of a door of a container of a truck stopping at the roadside at the next moment. It is understood that, it is necessary to prevent the dynamic objects in static state from hinder the driving of the vehicle when the state of the dynamic object changes.

In the step S1103, external contour lines are expanded outward by a predetermined distance along external contour lines of the one or more static objects to form expansion areas, when the one or more static objects are the dynamic objects in static state. In this embodiment, the outer contour of the static object is extracted from the static information, and the outer contour is extended outward by a predetermined distance. In this embodiment, the predetermined distance is 1 meter. In some other implement embodiments, the predetermined distance can be other suitable lengths. As shown in FIG. 12, for example, in the current surrounding environment, the dynamic object in the static state is the bus E which stops at the bus stop D, and then extends outward by 1 meter along the outer contour of the bus e to form the expansion area M of the bus E.

In the step S1105, the static regions occupied by the one or more static objects are obtained based on the expansion areas. In this embodiment, the static area occupied by bus E is the extending region M of bus E. In some other implement embodiments, the static area occupied by bus E can include the area occupied by bus E and the expansion area M near bus stop D.

In some implement embodiments, when a still pedestrian stands next to a still vehicle and extends a predetermined distance outward along the contour lines of the still pedestrian and the still vehicle respectively to form a pedestrian expansion area and a vehicle expansion area, the pedestrian expansion area may include the area between the pedestrian and the vehicle, and the vehicle expansion area may also include the area between the pedestrian and the vehicle.

In the above-mentioned embodiment, the predetermined distance is extended outward along the outer contour line of the dynamic objects in the static state to form an expansion area, which prevents the dynamic object in the static state at the current moment and becoming a dynamic state at the next moment from affecting the motion trajectory of the autonomous driving vehicle 30 being planned and make the driving of the autonomous driving vehicle safer.

When the static object is other recognizable object or immovable object, the static information about the static objects is extracted from the environment data, the static information includes but not limited to the static area occupied by the static object obtained directly from the environment data. As shown in FIG. 13, in this embodiment, both the construction signboard A and the temporary construction protective wall B are recognizable objects, so the area occupied by the construction signboard A is the static area, and the area occupied by the temporary construction protective wall B is also the static area.

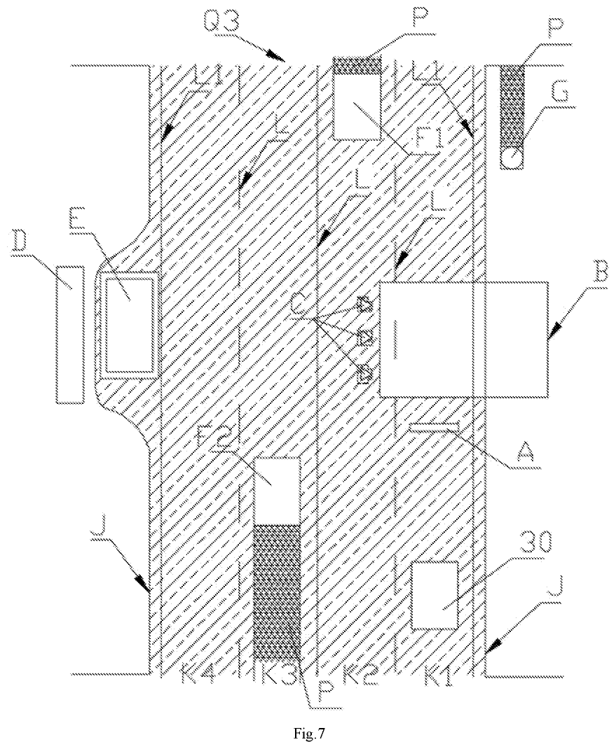

Referring to FIG. 4, FIG. 6 and FIG. 7, the step S114 of planning the second drivable area according to the first drivable area, the static information, the trajectories of the dynamic objects, and the lane information includes the following steps of S1142-S1144.

In the step S1142, the static region and the dynamic region occupied by the trajectories of the dynamic objects are removed from the first drivable area to generates a third drivable area. In detail, the planning module 37 obtains the dynamic region P occupied by the trajectories of the dynamic objects according to the trajectories of the dynamic object, and removes the static region and the dynamic region P from the first drivable area Q1, that is, the static region and the dynamic region P are deleted from the first drivable area Q1 to form the third drivable area Q3.

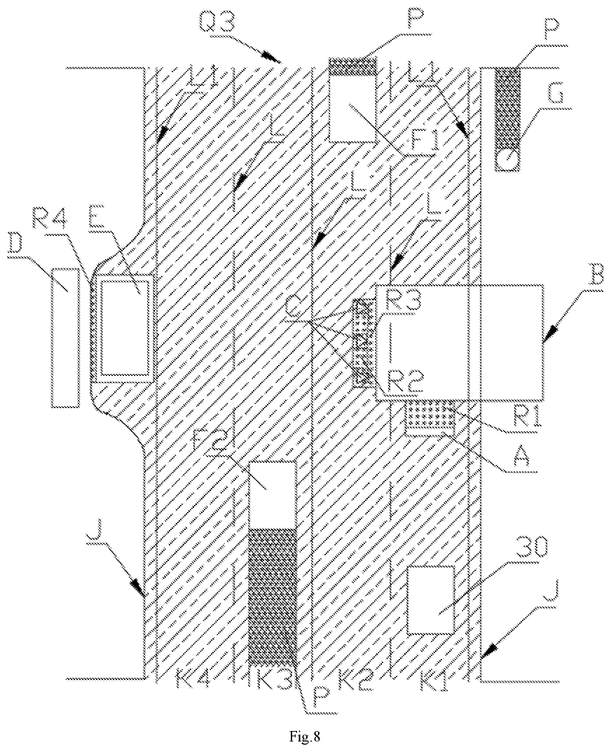

In some implement embodiments, the static information may also include slit areas between the static objects and the static objects, slit areas between the static objects and the road teeth J and so on. The slit areas are not large enough for the autonomous driving vehicle 30. In detail, when a distance between two the static regions or a distance between the static objects and the road teeth J does not reach the preset distance which is not large enough for the autonomous driving vehicle 30, the area between an area between two the static regions, or an area between the static objects and the road teeth J is determined as the slit area. As shown in FIG. 8, for example, the area R1 between the construction signboard A and the temporary construction protective wall B, the area R2 between the traffic cone C, the area R3 between the traffic cone C and the temporary construction protective wall B, and the area R4 between the bus E and the left curb J are all slit areas that unable the autonomous driving vehicle 30 to drive in. In order to generate the third drivable area Q3, the planning module 37 removes the static area, the slit area, and the dynamic area P from the first drivable area Q1 and the third drivable area Q3 is generated.

In the above-mentioned embodiment, the slit areas between the static areas and between the static areas and the road teeth that can't be driven by the autonomous driving vehicle are deleted from the first drivable area Q1, so that the planning of the autonomous driving vehicle trajectory is more in line with the reality.

In the step S1144, the second drivable area is planned according to the third drivable area and lane information. In detail, in the current surrounding environment, according to the lane information, the lanes being suitable for the autonomous driving vehicle 30 to drive on are Lane K1 and lane K2. However, the temporary construction of protective wall B and the traffic cone C occupy a part of lane K2, the autonomous driving vehicle 30 needs to cross the part of the lane L and drives on a part of the lane K3 to go away from the current area. When the autonomous driving vehicle 30 occupies the lane K3, the vehicle F2 will not affect the autonomous driving vehicle 30 according to analysis of a dynamic region P of the vehicle F2 in lane K3. Therefore, the second drivable area Q2 includes the shoulder between the right edge lines of the lane L1 and the right curb J, a part of the Lane K1 unoccupied, and a part of the lane K2 unoccupied, and a part of the lane K3.

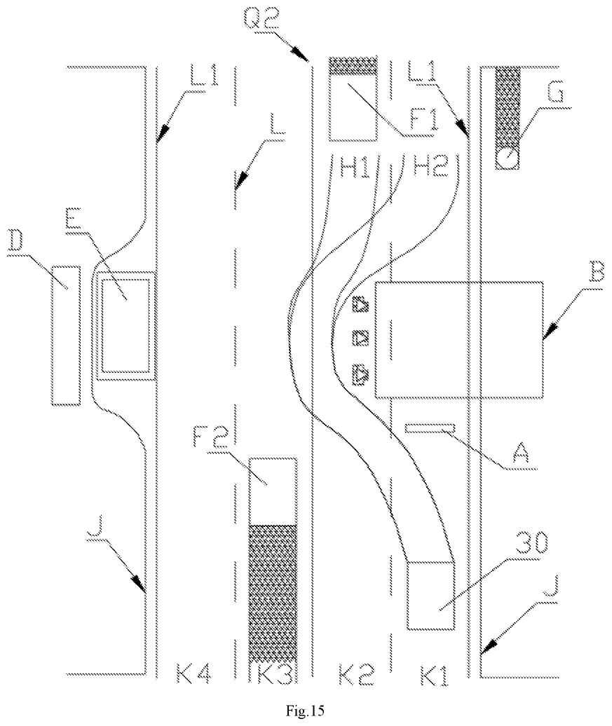

Referring to FIG. 14 and FIG. 15, a flow chart of the dynamic planning method of drivable area in accordance with a second embodiment. The dynamic planning method of drivable area in accordance with the second embodiment is different from the dynamic planning method of drivable area in accordance with the first embodiment that the dynamic planning method of drivable area in accordance with the second embodiment further comprises the following steps S116-S118.

In the step S116, the second drivable area is divided into a plurality of drivable routes. The plurality of drivable routes is arranging in order according to a preset rule. In detail, the planning module 37 analyzes the second drivable area Q2, and divides the second drivable area Q2 into plurality of drivable routes according to a size of the autonomous driving vehicle 30. The preset rule is to arrange plurality of drivable routes according to a driving distance of the drivable routes. In some other implement embodiments, the preset rule is to arrange plurality of drivable routes according to quantity of turns of drivable routes. As shown in FIG. 15, for example, the second drivable area Q2 can be divided into two drivable routes H1 and H2. In the drivable area H1, the autonomous driving vehicle 30 occupies a prat of the lane K3 to drive along the lane K2. In the drivable route H2, the autonomous driving vehicle 30 occupies the lane K3 to drives into the lane K1 and drives along the lane K1, so that the driving distance of the drivable route H1 is shorter than that of the drivable route H2.

In the step S118, an optimal driving route is selected from the plurality drivable routes to drive on. For example, the execution module 38 arranged on the autonomous driving vehicle 30 selects the optimal driving route from the drivable routes H1 and H2. The distance of the drivable route H1 is shorter than that of the drivable route H2, the drivable route H1 is selected as the optimal drivable route. However, the drivable route H1 is far away from the traffic cone C and the temporary construction protective wall B, the overall driving speed can be fast and stable, while the drivable route H2 is near the traffic cone C and the temporary construction protective wall B, and the autonomous driving vehicle 30 needs to slow down when becoming closer to the traffic cone C and the temporary construction protective wall B, and can be accelerated when becoming farther from the traffic cone C and the temporary construction protective wall B. Therefore, the drivable route H1 will not be satisfied each of the drivable routes H1 and H2 have advantages and disadvantages. The autonomous driving vehicle 30 can choose a route being suitable for a user as the optimal driving route according to the user's habits or the user's kind.

As described above, it is capable of planning dynamic trajectories by perceiving the environment around the autonomous driving vehicle at the current moment, and analyzing the lane information, the static information, and the dynamic information in the surrounding environment. In this embodiment, the drivable area for the autonomous driving vehicle includes the shoulder, the retrograde lane, the bicycle lane, and the roadside parking area, so that the autonomous driving vehicle can change lanes smoothly. Furthermore, the drivable area not only supports the autonomous driving vehicles to stop at the roadside in emergency, but also supports the autonomous driving vehicles to occupy the retrograde lane to realize the intelligent planning of the movement trajectory, which breaks the restriction of the lane to the autonomous driving vehicles and expands the planning ability of the autonomous driving vehicles.

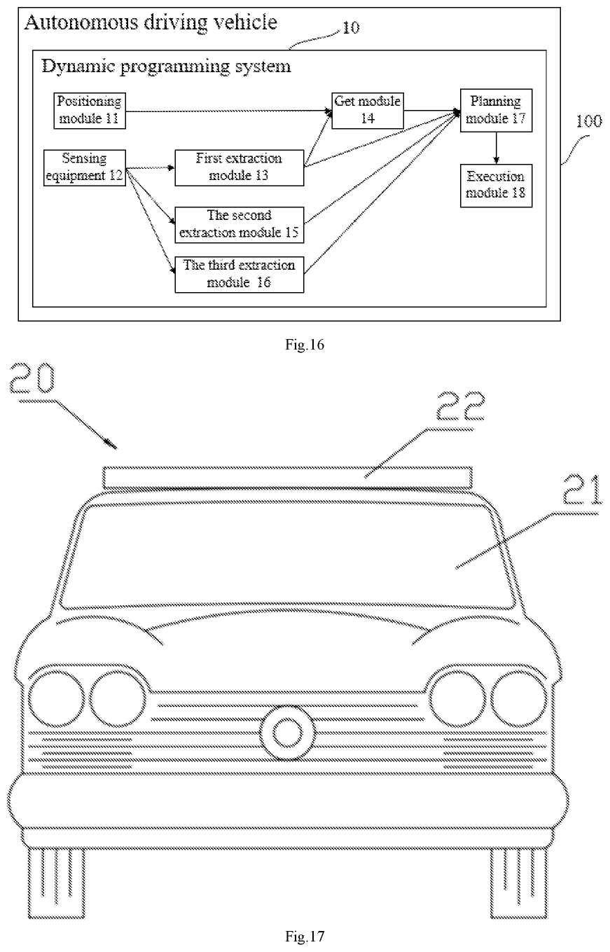

Referring to FIG. 16, a dynamic planning system 10 is installed in the autonomous driving vehicle 30 for planning dynamic trajectories for the autonomous driving vehicle 30 based on sensing data obtained by sensing device 12. The dynamic planning system 10 may be a program tool and include a plurality of program modules. In this embodiment, the dynamic planning system 10 includes a positioning module 11, a first extraction module 13, an acquisition module 14, a second extraction module 15, a third extraction module 16, and a planning module 17.

The sensing device 12 is configured to sense the environmental data of the surrounding environment of the autonomous driving vehicle. In detail, the sensing device 12 detects the environment around the autonomous driving vehicle 100 to obtain the sensing data, and then processes the sensing data based on the pre fusion sensing algorithm or the post fusion sensing algorithm to obtain the environment data. The sensing device 12 can be an integrated flat sensor device, a convex sensor device, or a split sensor device. The sensing device 12 includes but is not limited to radars, lidars, thermal imagers, image sensors, infrared instruments, ultrasonic sensors and other sensors with sensing function. The sensing data around the autonomous driving vehicle 100 is obtained via various sensors. The sensing data including but not limited to radar detection data, lidar detection data, thermal imager detection data, image sensor detection data, infrared detector detection data, ultrasonic sensor detection data, and so on.

The first extraction module 13 is configured to extract lane information about lanes from environment data. The lane information includes the location of the lane line.

The acquisition module 14 is configured to acquire a first drivable area of the autonomous driving vehicle according to the location of the autonomous driving vehicle at the current time, high-definition map, and lane information. The first drivable area includes a lane area between two lane edge lines and a shoulder between each edge lines of the lane and adjacent curbs. In some implement embodiments, the first drivable area also includes a bicycle lane, a roadside parking area, and the like for the autonomous driving vehicle 100.

The second extraction module 15 is configured to extract static information about static objects from the environment data. The, static objects include but are not limited to static vehicles, traffic cones, construction road signs, temporary construction protective walls, and so on. The static information includes locations of static objects and static areas occupied by the static objects.

The third extraction module 16 is configured to extract the dynamic information about dynamic objects from the environment data, and predict a motion trajectory of the dynamic objects according to the dynamic information. The dynamic objects include but are not limited to vehicles in the lane, pedestrians walking on the sidewalk, pedestrians crossing the road, and so on. The dynamic information includes but is not limited to locations of dynamic objects, the movement directions of the dynamic objects, the speeds of the dynamic objects and so on.

The planning module 17 is configured to plan the second drivable area according to the first drivable area, static information, motion trajectory and lane information. In detail, the planning module 17 is configured to remove the static area occupied by the static object and the dynamic area occupied by the trajectories from the first drivable area, and to plan the second drivable area according to the lane information.

The planning module 17 is also configured to divide the second drivable area into plurality drivable routes and arranges the drivable routes in order according to preset rules. In detail, the planning module 17 analyzes the second drivable area and divides the second drivable area into the plurality drivable routes according to the size of the autonomous driving vehicle 100. For example, the preset rule is to arrange the plurality of drivable routes according to a driving distance of the drivable routes. For another example, the preset rule is to arrange the plurality of drivable routes according to quantity of turns of the drivable routes.

The dynamic planning system 10 further includes an execution module 18. The execution module 18 is configured to select an optimal drivable route from numbers of drivable routes to drive on.

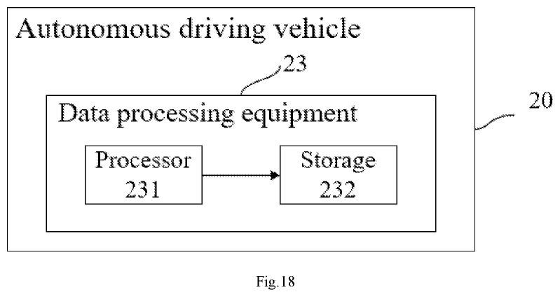

Referring to FIG. 17 and FIG. 18, the autonomous driving vehicle 20 includes a body 21, a sensing device 22 disposed on the body 21, and a data processing device 23. The sensing device 22 is configured to sense the environmental data of the environment around the autonomous driving vehicle. In this embodiment, the sensing device 22 is an integrated flat sensor device, and the sensing device 22 is arranged in the middle of the roof of the vehicle body 21. In some implement embodiments, the sensing device 22 is a convex sensor device which is not flat, or a split sensor device. It is understood that the sensing device 22 may be changed to other sensing device. The locations of the sensing device 22 on the vehicle body 21 can be changed to other locations. The data processing apparatus 23 includes a processor 231 and a memory 232. The data processing device 23, can be positioned on the sensing device 22 or on the vehicle body 21.

The memory 232 is configured to store program instructions.

The processor 231 is configured to execute the program instructions to enable the autonomous driving vehicle 30 to generate the dynamic planning method of drivable area as described above.

In some embodiments, the processor 231 can be a central processing unit, a controller, a microcontroller, a microprocessor or other data processing chip, which is configured to run the dynamic planning program instructions of the motion trajectory of the autonomous driving vehicle stored in the memory 232.

The memory 232 includes at least one type of readable storage medium including flash memory, hard disk, multimedia card, card type memory (E.G., SD or DX memory, etc.), magnetic memory, magnetic disk, optical disk, etc. The memory 232 may in some embodiments be an internal storage unit of a computer device, such as a hard disk of a computer device. In some other embodiments, the memory 232 may also be a storage device of an external computer device, such as a plug-in hard disk, an intelligent memory card, a secure digital card, a flash card, etc. provided on the computer device. Further, the memory 232 may include both an internal storage unit and an external storage device of the computer device. The memory 232 can not only be used to store the application software and various kinds of data installed on the computer equipment, such as the code of the dynamic planning method for realizing the motion trajectory of the autonomous driving vehicle, but also be used to temporarily store the data that has been output or will be output.

In the above embodiments, it may be achieved in whole or in part by software, hardware, firmware, or any combination thereof. When implemented in software, it can be implemented in whole or in part as a computer program product.

The computer program product includes one or more computer instructions. When the computer program instructions are loaded and executer on a computer, a process or function according to the embodiment of the disclosure is generated in whole or in part. The computer device may be a general-purpose computer, a dedicated computer, a computer network, or other programmable device. The computer instruction can be stored in a computer readable storage medium, or transmitted from one computer readable storage medium to another computer readable storage medium. For example, the computer instruction can be transmitted from a web site, computer, server, or data center to another web site, computer, server, or data center through the cable (such as a coaxial cable, optical fiber, digital subscriber line) or wireless (such as infrared, radio, microwave, etc.). The computer readable storage medium can be any available medium that a computer can store or a data storage device such as a serve or data center that contains one or more available media integrated. The available media can be magnetic (e.g., floppy Disk, hard Disk, tape), optical (e.g., DVD), or semiconductor (e.g., Solid State Disk), etc.

The technicians in this field can clearly understand the specific working process of the system, device and unit described above, for convenience and simplicity of description, can refer to the corresponding process in the embodiment of the method described above, and will not be repeated here.

In the several embodiments provided in this disclosure, it should be understood the systems, devices and methods disclosed may be implemented in other ways. For example, the device embodiments described above is only a schematic. For example, the division of the units, just as a logical functional division, the actual implementation can have other divisions, such as multiple units or components can be combined with or can be integrated into another system, or some characteristics can be ignored, or does not perform. Another point, the coupling or direct coupling or communication connection shown or discussed may be through the indirect coupling or communication connection of some interface, device or unit, which may be electrical, mechanical or otherwise.

The unit described as a detached part may or may not be physically detached, the parts shown as unit may or may not be physically unit, that is, it may located in one place, or it may be distributed across multiple network units. Some of the units can be selected according to actual demand to achieve the purpose of this embodiment scheme.

In addition, the functional units in each embodiment of this disclosure may be integrated in a single processing unit, or may exist separately, or two or more units may be integrated in a single unit. The integrated units mentioned above can be realized in the form of hardware or software functional units.

The integrated units, if implemented as software functional units and sold or used as independent product, can be stored in a computer readable storage medium. Based on this understanding, the technical solution of this disclosure in nature or the part contribute to existing technology or all or part of it can be manifested in the form of software product. The computer software product stored on a storage medium, including several instructions to make a computer equipment (may be a personal computer, server, or network device, etc.) to perform all or part of steps of each example embodiments of this disclosure. The storage medium mentioned before includes U disk, floating hard disk, ROM (Read-Only Memory), RAM (Random Access Memory), floppy disk or optical disc and other medium that can store program codes.

It should be noted that the embodiments number of this disclosure above is for description only and do not represent the advantages or disadvantages of embodiments. And in this disclosure, the term “including”, “include” or any other variants is intended to cover a non-exclusive contain. So that the process, the devices, the items, or the methods includes a series of elements not only include those elements, but also include other elements not clearly listed, or also include the inherent elements of this process, devices, items, or methods. In the absence of further limitations, the elements limited by the sentence “including a . . . ” do not preclude the existence of other similar elements in the process, devices, items, or methods that include the elements.

The above are only the preferred embodiments of this disclosure and do not therefore limit the patent scope of this disclosure. And equivalent structure or equivalent process transformation made by the specification and the drawings of this disclosure, either directly or indirectly applied in other related technical fields, shall be similarly included in the patent protection scope of this disclosure.

1. A dynamic planning method of drivable area, comprises:
obtaining a location of the autonomous driving vehicle at a current time;
perceiving environment data about environment around the autonomous driving vehicle;
extracting lane information about lanes from the environment data, the lane information comprising locations of lane lines of the lanes;
obtaining a first drivable area of the autonomous driving vehicle according to the location of the autonomous driving vehicle at the current time, a high-definition map, and the lane information, the first drivable area comprising lane areas locating between two edge lines of each lane, and a shoulder locating between each edge line of the lane and a curb respectively adjacent to each edge line of the lane;
extracting static information about static objects from the environment data, the static information containing locations of the static objects and regions of the static objects;
extracting dynamic information about dynamic objects from the environment data, and predicting trajectories of the dynamic objects according to the dynamic information; and
planning a second drivable area according to the first drivable area, the static information, the trajectories of the dynamic objects, and the lane information.

2. The dynamic planning method of drivable area according to claim 1, further comprising: sensing the environment around the autonomous driving vehicle to gather sensing data; wherein extracting the static information about static objects from the environment data comprising:
determining whether the static objects are unrecognizable objects;
constructing a grid map based on the sensing data when the static objects are unrecognizable objects; and
obtaining the static regions occupied by the static objects based on the grid map.

3. The dynamic planning method of drivable area according to claim 2, wherein obtaining the static region occupied by the static objects base on the grid map comprises:
determining grids of the grid map into an occupation state or an un-occupation state on the sensing data; and
obtaining the grids in the occupation state as the static regions.

4. The dynamic planning method of drivable area according to claim 2, wherein extracting static information about static objects from the environment data further comprising:
determining whether one or more of the static objects are the dynamic objects in static state;
expanding external contour lines outward by a predetermined distance along external contour lines of the one or more static objects to form expansion areas, when the one or more static objects are the dynamic objects in static state; and
obtaining the static regions occupied by the one or more static objects based on the expansion areas.

5. The dynamic planning method of drivable area according to claim 1, wherein perceiving environment data about environment around the autonomous driving vehicle comprises:
sensing the environment around the autonomous driving vehicle to gather sensing data; and
obtaining the environment data by perceiving the sensing data using a pre fusion prediction algorithm or a post fusion prediction algorithm.

6. The dynamic planning method of drivable area according to claim 1, wherein planning a second drivable area according to the first drivable area, the static information, the trajectories of the dynamic objects, and the lane information comprises:
dividing the second drivable area into plurality drivable routes, the drivable routes are sorted according to a preset rule; and
selecting the best driving route from plurality drivable routes and executing the best driving route.

7. The dynamic planning method of drivable area according to claim 1, wherein planning a second drivable area according to the first drivable area, the static information, the trajectories of the dynamic objects, and the lane information comprises:
removing the static region and dynamic regions that occupied by the trajectories of the dynamic objects from the first drivable area to generate a second drivable area; and
planning the second drivable area according to the third drivable area and the lane information.

8. The dynamic planning method of drivable area according to claim 1, further comprises:
dividing the second drivable area into a plurality of drivable routes;
arranging the drivable routes in preset order; and
selecting an optimal drivable route from the plurality of drivable routes to control the autonomous driving vehicle to drive along.

9. An autonomous driving vehicle, the autonomous driving vehicle comprising:
a memory configured to store program instructions; and
one or more processors configured to execute the program instructions to perform an dynamic planning method of drivable area, the dynamic planning method of drivable area for an autonomous driving vehicle comprising:
obtaining a location of the autonomous driving vehicle at a current time;
perceiving environment data about environment around the autonomous driving vehicle;
extracting lane information about lanes from the environment data, the lane information comprising locations of lane lines of the lanes;
obtaining a first drivable area of the autonomous driving vehicle according to the location of the autonomous driving vehicle at the current time, a high-definition map, and the lane information, the first drivable area comprising lane areas locating between two edge lines of each lane, and a shoulder locating between each edge line of the lane and a curb respectively adjacent to each edge line of the lane;
extracting static information about static objects from the environment data, the static information containing locations of the static objects and regions of the static objects;
extracting dynamic information about dynamic objects from the environment data, and predicting trajectories of the dynamic objects according to the dynamic information; and
planning a second drivable area according to the first drivable area, the static information, the trajectories of the dynamic objects, and the lane information.

10. The autonomous driving vehicle according to claim 9, wherein the dynamic planning method of drivable area further comprising: sensing the environment around the autonomous driving vehicle to gather sensing data; wherein extracting the static information about static objects from the environment data comprises:
determining whether the static objects are unrecognizable objects;
constructing a grid map based on the sensing data when the static objects are unrecognizable objects; and
obtaining the static regions occupied by the static objects based on the grid map.

11. The autonomous driving vehicle according to claim 10, wherein obtaining the static region occupied by the static objects from the grid map comprises:
determining grids of the grid map into an occupation state or an un-occupation state on the sensing data; and
obtaining the grids in the occupation state as the static regions.

12. The autonomous driving vehicle according to claim 11, wherein extracting static information about static objects from the environment data comprises:
determining whether one or more of the static objects are the dynamic objects in static state;
expanding external contour lines outward by a predetermined distance along external contour lines of the one or more static objects to form expansion areas, when the one or more static objects are the dynamic objects in static state; and
obtaining the static regions occupied by the one or more static objects based on the expansion areas.

13. The autonomous driving vehicle according to claim 9, wherein perceiving environment data about environment around the autonomous driving vehicle comprises:
sensing the environment around the autonomous driving vehicle to gather sensing data; and
obtaining the environment data by perceiving the sensing data using a pre fusion prediction algorithm or a post fusion prediction algorithm.

14. The autonomous driving vehicle according to claim 9, wherein planning a second drivable area according to the first drivable area, the static information, the trajectories of the dynamic objects, and the lane information comprises:
dividing the second drivable area into plurality drivable routes, the drivable routes are sorted according to a preset rule; and
selecting the best driving route from the plurality drivable routes to drive on.

15. The autonomous driving vehicle according to claim 9, wherein planning a second drivable area according to the first drivable area, the static information, the trajectories of the dynamic objects, and the lane information comprises:
removing the static region and dynamic regions that occupied by the trajectories of the dynamic objects from the first drivable area to generate a third drivable area; and
planning the second drivable area according to the third drivable area and the lane information.

16. The autonomous driving vehicle according to claim 9, wherein the dynamic planning method of drivable area further comprises:
dividing the second drivable area into a plurality of drivable routes;
arranging the drivable routes in preset order; and
selecting an optimal drivable route from the plurality of drivable routes to control the autonomous driving vehicle to drive along.

17. A medium, comprising a plurality of program instructions, the program instructions executed by one or more processors to perform a dynamic planning method of drivable area, the dynamic planning method of drivable area for an autonomous driving vehicle comprising:
obtaining a location of the autonomous driving vehicle at a current time;
perceiving environment data about environment around the autonomous driving vehicle;
extracting lane information about lanes from the environment data, the lane information comprising locations of lane lines of the lanes;
obtaining a first drivable area of the autonomous driving vehicle according to the location of the autonomous driving vehicle at the current time, a high-definition map, and the lane information, the first drivable area comprising lane areas locating between two edge lines of each lane, and a shoulder locating between each edge line of the lane and a curb respectively adjacent to each edge line of the lane;
extracting static information about static objects from the environment data, the static information containing locations of the static objects and regions of the static objects;
extracting dynamic information about dynamic objects from the environment data, and predicting trajectories of the dynamic objects according to the dynamic information; and
planning a second drivable area according to the first drivable area, the static information, the trajectories of the dynamic objects, and the lane information.

18. The medium according to claim 17, wherein sensing the environment around the autonomous driving vehicle to gather sensing data; wherein extracting the static information about static objects from the environment data comprises:
determining whether the static objects are unrecognizable objects;
constructing a grid map based on the sensing data when the static objects are unrecognizable objects; and
obtaining the static regions occupied by the static objects based on the grid map.

19. The medium according to claim 18, wherein obtaining the static region occupied by the static objects base on the grid map comprises:
determining grids of the grid map into an occupation state or an un-occupation state on the sensing data; and
obtaining the grids in the occupation state as the static regions.

20. The medium according to claim 18, wherein extracting static information about static objects from the environment data comprises:
determining whether one or more of the static objects are the dynamic objects in static state;
expanding external contour lines outward by a predetermined distance along the external contour lines of the one or more static objects to form expansion areas, when the one or more static objects are the dynamic objects in static state; and
obtaining the static regions occupied by the one or more static objects based on the expansion areas.
